(19) United States
(12) Patent Application Publication
(10) Pub. No.: US 2013/0153381 A1
(43) Pub. Date: Jun. 20, 2013

(54) Shield Apparatus for Use in Circuit Interrupter

(71) Applicants: James Gerard Maloney, Industry, PA (US); Jeffrey Wayne Lockhart, Pittsburgh, PA (US)

(72) Inventors: James Gerard Maloney, Industry, PA (US); Jeffrey Wayne Lockhart, Pittsburgh, PA (US)

(21) Appl. No.: 13/328,044

(22) Filed: Dec. 16, 2011

(51) Int. Cl. H01H 9/00

(52) U.S. Cl. 200/304

(57) ABSTRACT

An improved shield apparatus is structured to resist contamination due to an electrical arc event of an open region that is formed within an interior of a circuit interrupter. The open region is one within which a coil spring is movably disposed. The improved shield apparatus is formed of a flexible sheet of arc-resistant material and includes a support apparatus having an elongated leg, at least a portion of which extends through an elongated longitudinal opening in the coil spring and connects with an end of the coil spring. The shield apparatus further includes a shield element that is situated on an exterior surface of the coil spring and is structured to overlie at least a portion of an opening into the open region.

### BACKGROUND OF THE INVENTION

1. Field of the Invention

The disclosed and claimed concept relates generally to circuit interrupters and, more specifically, to a shield apparatus that is structured to resist contamination due to an electrical arc event of an open region within a circuit interrupter.

2. Background Information

Circuit interrupters are employed in numerous applications. As is generally understood, circuit interrupters typically include a set of separable contacts which, when separated, interrupt current flowing through a circuit. However, at the moment of separation of the separable contacts, an electrical arc sometimes forms between the contacts, and any such arc is desirably extinguished as soon as possible due to the potential for damage to the circuit interrupter.

For instance, an arc between the separable contacts has a tendency to degrade the contact surfaces by vaporizing the metal of the contacts. Moreover, such vaporized metal forms a plasma that can undesirably condense and become deposited on structures within the interior of the circuit interrupter. Such deposits can interfere with the mechanical operations of the circuit interrupter and can have other undesirable effects. While various devices and strategies for minimizing the effects of electrical arcs within the interiors of circuit interrupters have been implemented, limitations have existed. For example, mechanical devices within the interior of a circuit interrupter that have a small physical clearance between them are particularly susceptible to fouling and obstructed operation when the plasma from an electrical arc is deposited in the vicinity of the small physical clearance. Improvements would be desirable.

### SUMMARY OF THE INVENTION

An improved shield apparatus is structured to resist contamination due to an electrical arc event of an open region that is formed within an interior of a circuit interrupter. The open region is one within which a coil spring is movably disposed. The improved shield apparatus is formed of a flexible sheet of arc-resistant material and includes a support apparatus having an elongated leg, at least a portion of which extends through an elongated longitudinal opening in the coil spring and connects with an end of the coil spring. The shield apparatus further includes a shield element that is situated on an exterior surface of the coil spring and is structured to overlie at least a portion of an opening into the open region.

Accordingly, an aspect of the disclosed and claimed concept is to provide an improved shield apparatus that resists contamination due to an electrical arc event of an open region that is formed in a portion of an interior of a circuit interrupter.

Another aspect of the disclosed and claimed concept is to provide such an improved shield apparatus that is mounted on a coil spring of a circuit interrupter and that is movable with the coil spring when the circuit interrupter moves between an ON condition and an OFF condition.

Another aspect of the disclosed and claimed concept is to provide such an improved shield apparatus having an elongated leg, at least a portion of which is structured to extend through an elongated longitudinal opening in the coil spring.

These and other aspects of the disclosed and claimed concept are provided by an improved shield apparatus that is structured to resist contamination due to an electrical arc event of an open region that is formed in a portion of a circuit interrupter and within which a coil spring is movably disposed. The shield apparatus can be generally stated as including a support apparatus and a shield element. The support apparatus can be generally stated as including a first support portion having an elongated leg, at least a portion of the leg being structured to extend through an elongated longitudinal opening in the coil spring. The shield element is disposed on the support apparatus and is structured to overlie at least a portion of the coil spring and at least a portion of an opening into the open region.

### BRIEF DESCRIPTION OF THE DRAWINGS

A further understanding of the disclosed and claimed concept can be gained from the following Description of the Preferred Embodiment when read in conjunction with the accompanying drawings in which:

FIG. 1 is a perspective view of an improved shield apparatus in accordance with the disclosed and claimed concept in a position spaced from a coil spring of a circuit interrupter;

FIG. 2 is a view similar to FIG. 1, except depicting the shield apparatus partially installed on the coil spring;

FIG. 3 is a view similar to FIG. 2, except depicting the shield apparatus fully installed on the coil spring;

FIG. 4 is a partially cut away depiction of a circuit interrupter in an ON condition on which the shield apparatus is installed;

FIG. 4A is an enlarged view of an indicated portion of FIG. 4;

FIG. 5 is a view similar to FIG. 4, except depicting the circuit interrupter in an OFF condition;

FIG. 6 is a schematic depiction of the improved shield apparatus extending across a portion of an open region of the circuit interrupter in the ON condition as in FIGS. 4 and 4A; and

FIG. 7 is a view similar to FIG. 6, except depicting the shield apparatus on the circuit interrupter in the OFF condition as in FIG. 5.

Similar numerals refer to similar parts throughout the specification.

### DESCRIPTION OF THE PREFERRED EMBODIMENTS

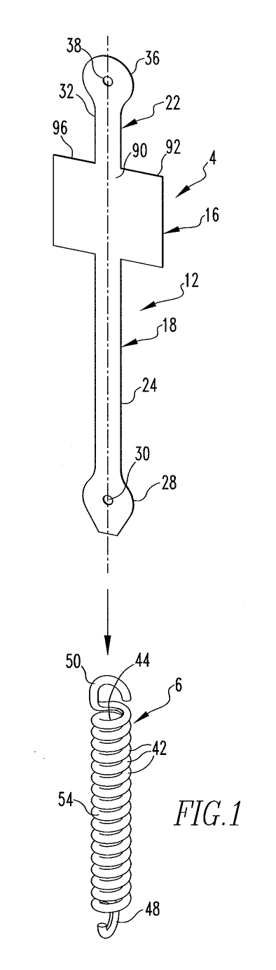

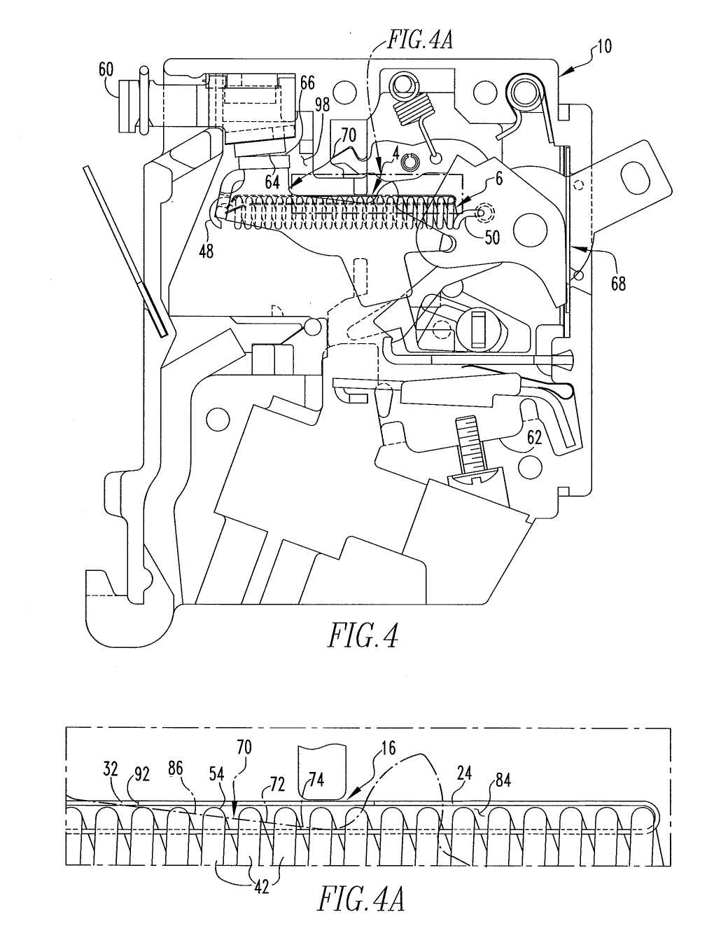

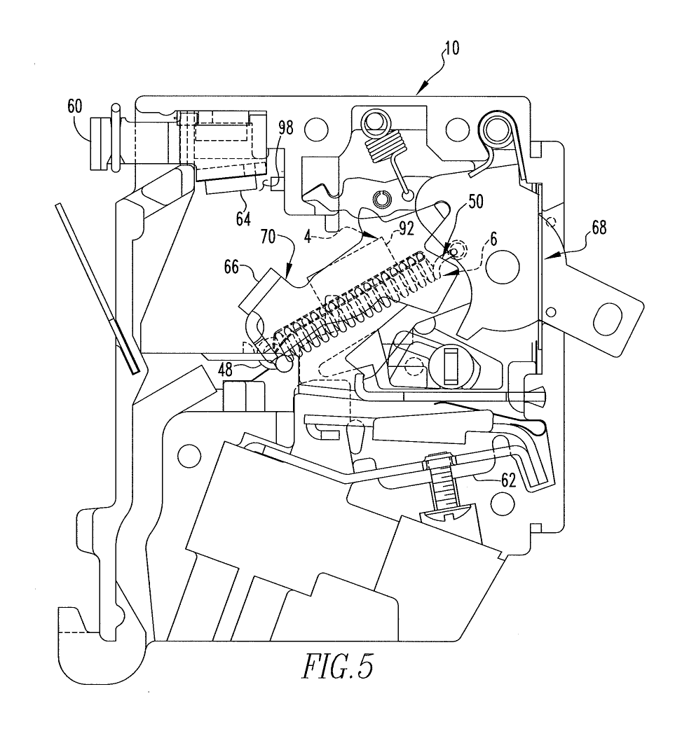

An improved shield apparatus 4 is depicted in FIG. 1 as being spaced from a coil spring 6 of a circuit interrupter 10, an example of which is depicted generally in FIGS. 4-5. As will be discussed in greater detail below, the circuit interrupter 10 has an open region formed therein, and the shield apparatus 4 is advantageously mounted on the coil spring 6 and is movable with the coil spring 6 to resist contamination of the coil spring 6 and the open region of the circuit interrupter 10 within which the coil spring 6 is movably disposed

The shield apparatus 4 can be said to include a support apparatus 12 and a shield element 16, with the shield element 16 being disposed on the support apparatus 12. The support apparatus 12 can be said to include a first support portion 18 and a second support portion 22 that are connected with the shield element 16 and that extend in opposite directions away from the shield element 16.

As is best shown in FIGS. 1 and 2, the first support portion 18 can be said to include an elongated first leg 24 and a first connection element 28. The first connection element 28 has a first hole 30 formed therein. The first connection element 28 is situated on an end of the first leg 24 opposite the shield element 16.

Likewise, the second support portion 22 can be said to include an elongated second leg 32 and a second connection element 36. The second connection element 36 is situated on the second leg 32 opposite its connection with the shield element 16. The second connection element 36 has a second hole 38 formed therein.

In the exemplary embodiment depicted herein, the exemplary coil spring 6 is an elongated helical tension spring, but it is understood that in other embodiments not expressly depicted herein, the coil spring 6 can be of other forms without departing from the present concept. The coil spring 6 can be said to comprise a plurality of helical coils 42 that extend about a longitudinal opening 44 that is formed centrally in the coil spring 6. The coil spring 6 further includes a first end 48 having a hook and a second end 50 that likewise has a hook, with the first and second ends 48 and 50 being opposite one another. The coil spring 6 further includes an exterior surface 54 that can be said to extend along the coils 42.

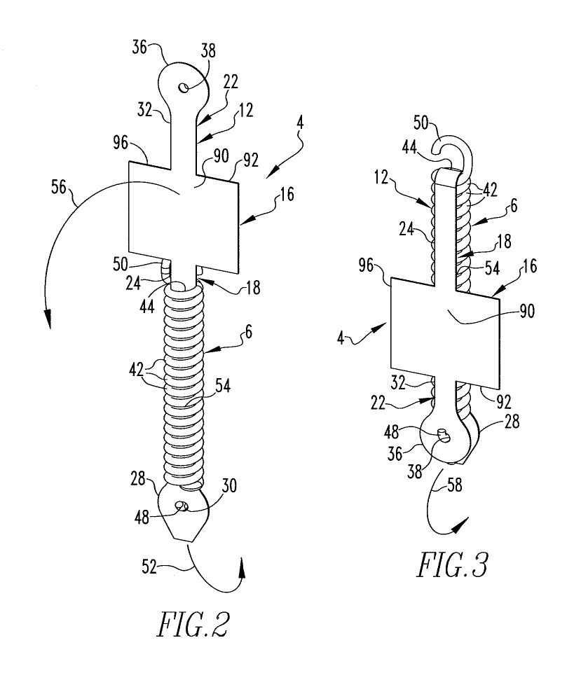

As can be understood from FIGS. 1 and 2, the shield apparatus 4 is initially installed on the coil spring 6 by receiving the elongated first leg 24 through the longitudinal opening 44 in the coil spring 6 until the first connection element 28 reaches the first end 48. The hook at the first end 48 is then received in the first hole 30, as is indicated with the arrow 52 in FIG. 2. More specifically, the free end of the hook is advanced through the first hole 30 sufficiently to cause the first connection element 28 to be situated on the leg of the hook that is directly connected with a coil 42, i.e., the leg that is opposite the free end of the hook, in order to avoid the hook from becoming unintentionally dislodged from the first hole 30 during movement or deflection of the spring 6. The first leg 24 can then be folded back on itself, as is indicated at the arrow 56 in FIG. 2, such that a portion of the first leg 24 and the shield apparatus 4 overlie the exterior surface 54. In such a situation, the second leg 32 typically also extends across the exterior surface 54. The hook at the first end 48 is then received in the second hole 38, as is indicated at the arrow 58 in FIG. 3, and the hook is advanced through the hole 38 sufficiently that the second connection element 36 is situated on the leg of the hook opposite the free end thereof. That is, the same first end 48 is received through both the first and second holes 30 and 38, and the first and second connection elements 28 and 36 are situated on the leg of the hook that is directly connected with one of the coils 42 to retain the shield apparatus 4 disposed on the coil spring 6.

In FIGS. 4 and 5, the coil spring 6 having the shield apparatus 4 installed thereon is depicted as being installed within the interior of the circuit interrupter 10. The circuit interrupter 10 can be said to include a line conductor 60 and a load conductor 62 that are connectable together with a stationary contact 64 and a movable contact 66 which, in FIG. 4, are depicted as being electrically connected together. FIG. 4 thus depicts the circuit interrupter 10 in an ON condition. The circuit interrupter 10 further includes an operating mechanism that is indicated generally at the numeral 68 to move the circuit interrupter between the ON condition and an OFF condition and which includes a movable contact arm 70 upon which the movable contact 66 is mounted.

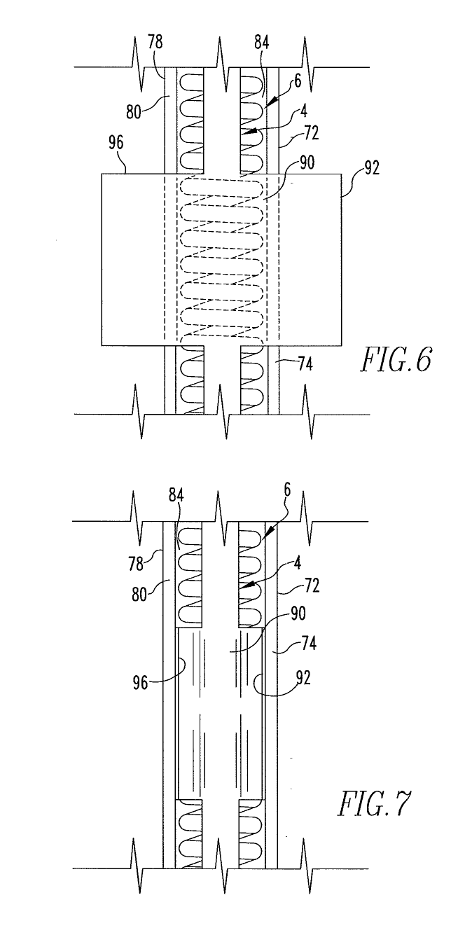

FIG. 4A is an enlarged depiction of a portion of FIG. 4 that shows a portion of the shield apparatus 4 situated on the exterior surface 54 of the coil spring 6 and that further depicts the shield element 16 extending across a portion of the movable contact arm 70. Such extension of the shield element 16 across a portion of the movable contact arm 70 is depicted in greater detail in FIG. 6 which is another depiction of a portion of the circuit interrupter 10 in an ON condition. More specifically, it can be seen from FIG. 6, and from FIG. 7, that the movable contact arm 70 can be said to include a first arm element 72 having a first frontal surface 74 and a second arm element 78 having a second frontal surface 80. An open region 84 can thus be said to exist between the first and second arm elements 72 and 78. The open region 84 can be said to have an opening 86 (FIG. 4A) that is disposed generally between the first and second frontal surfaces 74 and 80.

As can be understood from FIGS. 4, 4A, and 6, in the ON condition of the circuit interrupter 10 the shield element 16 overlies the first and second arm elements 72 and 78. In particular, the shield element 16 can be said to include a main shield element that extends between the first and second legs 24 and 32, and can further be said to include a first shield wing 92 and a second shield wing 96 disposed at opposite sides of the main shield element 90. In the ON condition of the circuit interrupter 10, the first shield wing 92 overlies the first arm element 72 adjacent the first frontal surface 74. The second shield wing 96 can be said to overlie the second arm element 78 adjacent the second frontal surface 80. Such initial positioning of the shield 5. element 16 advantageously resists contamination of the spring 6 and the open region 84 during the initial separation of the stationary and movable contacts 64 and 66 and any initial generation of an electrical arc therebetween.

As can be understood from FIGS. 5 and 7, however, in the OFF condition of the circuit interrupter 10, the movable contact 66 can be seen to have been moved away from the stationary contact 64 and to be out of electrical connection therewith. Such separation occurred due to pivoting of the movable contact arm 70 in the counter-clockwise direction from the perspective of FIG. 5. In moving from the ON condition to the OFF condition of the circuit interrupter 10, it can be seen that the coil spring 6 and the shield apparatus 4 connected thereto have moved farther (generally downward, from the perspective of FIG. 5) into the open region 84 in a position farther away from the first and second frontal surfaces 74 and 80, which has caused the first and second shield wings 92 and 96 to be pulled into the open region 84 rather than being situated outside the open region 84 and overlying the first and second frontal surfaces 74 and 80. However, it can be seen from FIG. 7 that the first and second shield wings 92 and 96 have become engaged with the opposed surfaces of the first and second arm elements 72 and 78. Such movement of the shield element 16 with the coil spring 6 and continued sealing movement of the first and second shield wings 92 and 96 with respect to the first and second arm elements 72 and 78 advantageously further resists contamination of the coil spring 6 and the open region 84 due to an arc event within the interior of the circuit interrupter 10 upon further movement of the movable contact arm 70 toward the OFF condition of the circuit interrupter 10.

As can be seen in FIGS. 4 and 5, the circuit interrupter 10 includes an arc region 98 within the interior thereof that is in the vicinity of the stationary and movable contacts 64 and 66 in their connected condition. When the movable contact 66 is moved away from the stationary contact 64, any arc that forms between the movable and stationary contacts 66 and 64 will typically be disposed in the arc region 98. However, it can also be seen from FIGS. 4 and 5 that the shield element 16 is generally interposed between the arc region 98 and at least a portion of the coil spring 6. The shield element 16 thus resists arc plasma and gases from passing into the open region 84, and thus advantageously resists the fouling of the open region 84 and the coil spring 6 that is movably disposed therein due to an arc event. That is, the coil spring 6 is movably situated in the open region 84 with minimal clearance between the coil spring 6 and the first and second arm elements 72 and 78. The provision of the shield element 16 advantageously resists plasma and arc gases from entering the open region 84, which promotes reliable operation of the circuit interrupter 10 and resists fouling thereof due to an arc event.

The length of the shield element 16 in a direction parallel with the longitudinal extent of the first leg 24 can be varied depending upon the needs of the particular application. Moreover, the width of the shield element 16 in a direction transverse to the longitudinal extent of the first leg 24 can likewise be varied depending upon the needs of the particular application. As can be clearly seen from FIGS. 1-3, the width of the shield element 16 in a direction transverse to the longitudinal extent of the first leg 24 is at least three times the width of the first leg 24 itself in a direction transverse to its longitudinal extent. Depending upon the dynamics of the coil spring 6 and other components of the circuit interrupter 10, and other factors such as the clearance between the coil spring 6 and the open region 84, the extent to which the coil spring 6 moves into the open region, and other factors, the positioning of the shield element 16 on the support apparatus 12 as well as the dimensions of the shield element 16 can be varied to suit the needs of the particular application.

The shield apparatus 4 is thus is mounted to the coil spring 6 and advantageously moves therewith when the circuit interrupter 10 moves between the ON and OFF conditions. The shield apparatus 4 advantageously is situated between the arc region 98 and the coil spring 6, and it thus resists contamination of the open region 84 and the coil spring 6 due to-an arc event. This promotes continued reliable operation of the circuit interrupter 10, which is desirable.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A shield apparatus structured to resist contamination due to an electrical arc event of an open region that is formed in a portion of a circuit interrupter and within which a coil spring is movably disposed, the shield apparatus comprising:
a support apparatus comprising a first support portion having an elongated leg, at least a portion of the leg being structured to extend through an elongated longitudinal opening in the coil spring; and
a shield element disposed on the support apparatus and being structured to overlie at least a portion of the coil spring and at least a portion of an opening into the open region.

2. The shield apparatus of claim 1 wherein the first support portion further comprises a connection element structured to be connected with an end of the spring.

3. The shield apparatus of claim 2 wherein the connection element is disposed at an end of the leg opposite the shield element.

4. The shield apparatus of claim 3 wherein the support apparatus further comprises a second support portion comprising another connection element, the first support portion extending in a first direction away from a first end of the shield element, the second support portion extending in a second direction away from a second end of the shield element, the first and second directions being opposite one another.

5. The shield apparatus of claim 4 wherein the another connection element is structured to be connected with the end of the spring.

6. The shield apparatus of claim 5 wherein the connection element and the another connection element each have formed therein a hole that is structured to receive therein at least a portion of the end of the spring.

7. The shield apparatus of claim 1 wherein the shield apparatus is formed of a flexible sheet of material.

8. The shield apparatus of claim 7 wherein the shield element has a width measured transverse to the longitudinal extent of the leg that is at least three times the width of the leg measured transverse to its longitudinal extent.

9. The shield apparatus of claim 1 wherein the circuit interrupter is movable between an ON condition and an OFF condition, and wherein at least a portion of the shield apparatus is structured to be movable with the coil spring during movement of the circuit interrupter between the ON and OFF conditions.

10. A circuit interrupter comprising a coil spring movably disposed in an open region that is formed in an interior of the circuit interrupter, and further comprising the shield apparatus of claim 1 installed on the coil spring.
